(19) United States
(12) Patent Application Publication
(10) Pub. No.: US 2024/0406013 A1
(43) Pub. Date: Dec. 5, 2024

(54) SYSTEM AND METHOD FOR DECENTRALIZED TIMESTAMPING OF A SUBMISSION OF CONTENT ONTO A BLOCKCHAIN

(71) Applicant: UREEQA INC., Kitchener (CA)

(72) Inventors: Harsch KHANDELWAL, Kitchener (CA); Matt DE JONG, Kitchener (CA)

(21) Appl. No.: 18/695,873

(22) PCT Filed: Sep. 30, 2022
(86) PCT No.: PCT/CA2022/051456

§ 371 Date: Mar. 27, 2024

Related U.S. Application Data
(60) Provisional application No. 63/250,436, filed on Sep. 30, 2021.

(51) Int. Cl. H04L 9/32; H04L 9/00

(52) U.S. Cl. CPC H04L 9/3297; H04L 9/3236; H04L 9/50

(57) ABSTRACT

Group A and B A method and system for timestamping a submission of content onto a blockchain. The method and system comprising steps for receiving a set of submissions, generating a timestamp for the set of submissions, generating a hash for each of the set of submissions, writing the set of submissions, the timestamp and each generated hash to the blockchain after the hash has been generated. The hash may include identification information. Group C A method for timestamping verification of a submission that has been written to a blockchain. The method comprising steps for receiving a verification request; generating a verification hash based on the verification request; and searching a master file on the blockchain for the verification hash.

### CROSS-REFERENCE TO OTHER APPLICATIONS

The current disclosure claims priority from U.S. Provisional Application No. 63/250,436 filed Sep. 30, 2021, which is hereby incorporated by reference.

### FIELD

The present disclosure relates generally to blockchain technology and more specifically, to a system and method for decentralized timestamping of a submission of content onto a blockchain.

### BACKGROUND

In the advancing age of technology, use of blockchain technology continues to grow. A blockchain may be seen as a distributed database or ledger that is shared among the nodes of a computer network. As a database, a blockchain stores information electronically in digital format. In some cases, there is a benefit to timestamping the storage of information onto a blockchain, such as in the protection of creative works or intellectual property.

In the digital age, there are more and more varieties of creative works being made and copied by others. Unfortunately, the protection of those creative works can be complicated, ineffective and expensive. For example, one type of intellectual property protection that is regularly sought is copyright protection. Copyright protection provides the exclusive legal right, given to an originator/creator of the intellectual property or an assignee of the intellectual property to print, publish, perform, film, or record literary, artistic, or musical material, and to authorize others to do the same. The copyright is associated with an intangible legal intellectual property right associated with the creator of the tangible intellectual property. Copyright ownership is typically enforced through the legal system providing a foundation to enforce any financial benefit associated with the copyright. Other forms of intellectual property protection may include patents, trademarks and industrial designs.

Some problems with copyright protection is that many legacy copyright agencies require that copyright registration be completed through physical documents or through outdated online information collection systems. In addition, many copyright registration agencies do not collect the piece of creative work itself as part of the registration, making it less effective in cases of future infringement. In general, protection for intellectual property is generally registered on a national basis, with each registry having their own rules and costs. Also, the existing system relies on centralized organizations that have their own technological and regulatory limitations. Therefore, it would be beneficial to provide a system using blockchain for protecting intellectual property. However, in the intellectual property protection world, the timing of a submission or when a creative work is created is important and capturing these dates is required.

Therefore, there is provided a novel system and method for decentralized timestamping a submission of content onto a blockchain.

### SUMMARY

In the following, while a method and system for decentralized timestamping of copyright is disclosed, it is understood that the method and system may be applied to other forms of intellectual property such as, but not limited to, patents, trademarks and industrial designs.

Generally, the present disclosure provides a system and method for protecting intellectual property. In one aspect, there is provided a method system for protecting intellectual property whereby intellectual property is recorded/timestamped on the blockchain.

In another aspect, there is provided a method and system for protecting intellectual property whereby intellectual property is recorded/timestamped as a batch on the blockchain.

In another aspect, there is provided a method and system for protecting intellectual property whereby supporting documents are included and/or referenced in the record/timestamp on the blockchain.

In yet another aspect, there is provided a method and system for protecting intellectual property whereby additional information, similar to information that National copyright registration agencies collect, is included and/or referenced in the record/timestamp that is on the blockchain.

In a further aspect, there is provided a method and system for protecting intellectual property whereby a secret phrase is used in the batch record/timestamp on the blockchain.

In an aspect, there is provided a method and system for protecting intellectual property whereby intellectual property is recorded/timestamped on the blockchain where the user has the ability to use their own hashing function for creative work that is especially private to the user.

In a further aspect, there is provided a method and system for protecting intellectual property whereby intellectual property is recorded/timestamped on the blockchain where the user has the ability to cryptographically secure their creative work for those works that are especially private to the user.

In one aspect of the disclosure, there is provided a method for decentralized timestamping of a submission of content onto a blockchain including receiving a set of submissions; generating a hash for each of the set of submissions; and writing each hash to the blockchain.

In another aspect, the set of submissions includes at least two submissions. In a further aspect, writing each hash to the blockchain includes generating a secret string for each of the set of submissions; generating a secret string and submission hash for each of the set of submissions; generating a master file hash including each of the secret string and submission hashes; and writing the master file hash to the blockchain. In yet a further aspect, before generating a hash for each of the set of submissions, transmitting each of the set of submissions to a hash generating module. In yet another aspect, each of the set of submissions includes a creative work; and at least one of additional information or supporting documents. In a further aspect, the set of submissions includes a single submission. In yet another aspect, the hash includes a creative work associated with the single submission. In an aspect, the hash includes supporting documents associated with the creative work. In another aspect, the hash includes additional documents associated with the creative work.

In another aspect of the disclosure, there is provided a system for decentralized timestamping of a submission of content onto a blockchain including a processor for receiving a set of submissions for decentralized timestamping; at least one timestamping module for generating a timestamp for the set of submissions; and a hash generating module for generating a hash for each of the set of submissions; wherein the processor writes the set of submissions, a timestamp and the hash to the blockchain after the hash has been generated.

In a further aspect, the at least one timestamping module is a batch timestamping module. In another aspect, the batch timestamping module generates a secret string for each of the set of submissions and the hash generating module generates a hash for each of the set of submissions. In yet another aspect, the hash generating module generates a secret string and submission hash for each of the set of submissions. In yet a further aspect, the hash generating module generates a master file hash comprising each of the secret string and submission hashes.

In a further aspect of the disclosure, there is provided a method of timestamping verification of a submission that has been written to a blockchain including receiving a verification request; generating a verification hash based on the verification request; and searching a master file on the blockchain for the verification hash.

In another aspect, the method includes determining if the master file is listed within a smart contract associated with the blockchain if the verification hash is found in the master file. In yet another aspect, searching a master file on the blockchain for the verification hash includes comparing the verification hash with a list of previously generated hashes stored within the master file.

### DESCRIPTION OF THE DRAWINGS

Embodiments will now be described, by way of example only, with reference to the attached drawings, in which:

FIG. 1 illustrates an embodiment of the system herein and an environment for the system;

FIG. 2 is a schematic diagram of an apparatus for decentralized timestamping of a submission of content onto a blockchain;

FIG. 3 is a flowchart outlining one method of decentralized timestamping a submission of content onto a blockchain;

FIG. 4a is a flowchart outlining a first method of decentralized batch timestamping of a set of submissions onto a blockchain;

FIG. 4b is a flowchart outlining a second method of decentralized batch timestamping of a set of submissions onto a blockchain;

FIG. 5 is an example of a master file;

FIG. 6a is a flowchart outlining a first method of decentralized timestamping of an individual submission onto a blockchain;

FIG. 6b is a flowchart outlining a second method of decentralized timestamping of an individual submission onto a blockchain;

FIG. 7 are a set of photographs showing an example of different types of supporting documents;

FIG. 8a is a flowchart outlining a first method of batch timestamping verification;

FIG. 8b is a flowchart outlining a second method of batch timestamping verification;

FIG. 9a is a flowchart outlining a first method of decentralized individual stakes claim verification; and

FIG. 9b is a flowchart outlining a second method of decentralized individual stakes claim verification.

### DETAILED DESCRIPTION

The disclosure is directed at a method and system for the timestamping of a submission onto a blockchain. In one embodiment, when a request to make a submission or to save data or information onto a blockchain is received, the disclosure timestamps the submission and stores, or writes, the submission and the timestamp onto the blockchain. In the following description, use of the terms intellectual property and creative works will be interchangeable.

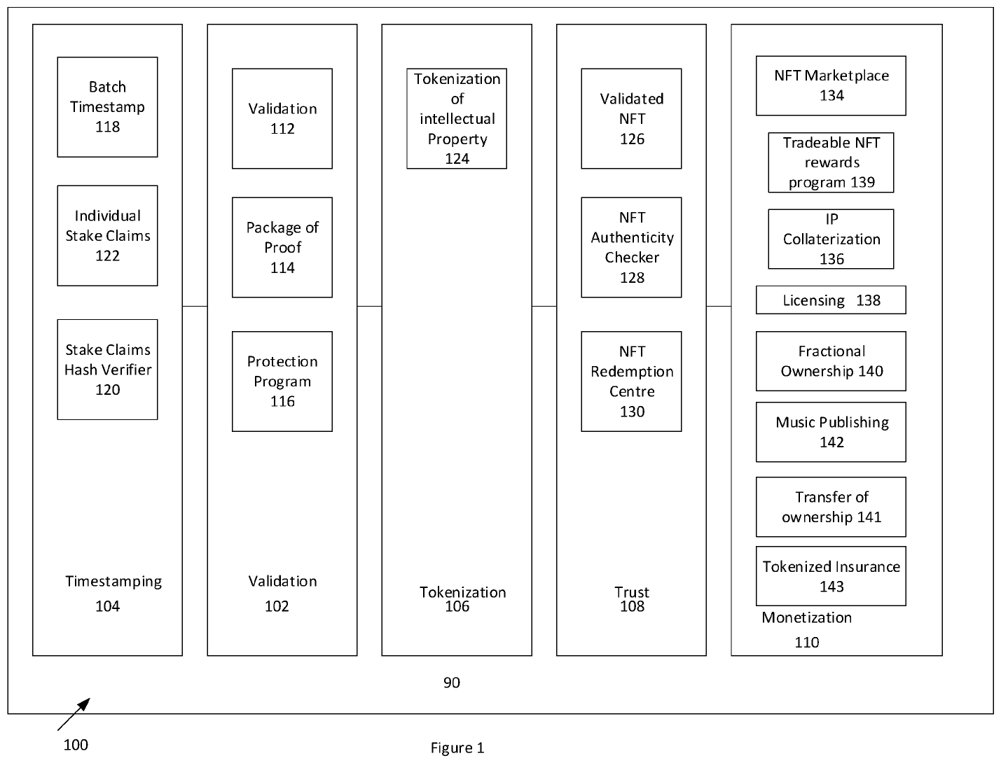

Turning to FIG. 1, a schematic diagram of a system for protecting, managing and/or monetizing creative works is shown. In one embodiment, the system 100 provides a process and functionality for creators to apply various levels of protection to their creative work, tools to verify the protection of that creative work, processes to provide ongoing monitoring of their creative work, and processes to monetize their creative work using a combination of traditional and blockchain technology. The system 100 may be stored or implemented via a server 90 (such as a web server) that may be in communication with a file server, a database and a blockchain. The system 100 includes at least one processor for executing a program or programs that implement the functionality described herein. In operation, a creator or user interacts with the system from a user computing device, such as, but not limited to, a computer or a smart device.

In the current embodiment, the system 100 includes a decentralized validation of intellectual property (IP), or validation, component 102; a decentralized timestamping of intellectual property, or timestamping, component 104; an enforceable and divisible tokenization of intellectual property, or tokenization, component 106; an encapsulating trust mechanisms into non-fungible tokens (NFTs), or trust, component 108; and a monetization component 110.

With respect to the timestamping component 104, the timestamping component 104 enables creators to post a permanent record (with a timestamp) of their creative work to the blockchain, in a short period of time, such as in minutes. The timestamping component 104 records the claim, or submission, of the creative work as a public, immutable record on a blockchain that the creator can use to prove the creative work is theirs. In one embodiment, the decentralized timestamping of intellectual property component 104 allow claims of ownership to be made quickly and inexpensively by creating, for example, a one-way hash of a submitted creative work on a blockchain (for example, a public blockchain such as Ethereum). This may be seen as a process of decentralized timestamping of intellectual property.

Once a claim of ownership is made, the blockchain will store immutable proof to secure the timestamp of submission. In the current embodiment, the decentralized timestamping of intellectual property component 104 includes a batch timestamp component 118, a stake claim hash verifier component 120 and an individual stake claims component 122. The batch timestamp component 118 and the individual stake claims component 122 may be seen as two modules, executing on the processor that is in communication with a blockchain, that may be able to perform the timestamping of intellectual property on, or to, the blockchain. In one embodiment, the decentralized timestamping of intellectual property component may enable creative works to be created as a record on the blockchain in a batch manner (via batch timestamp component 118) or individually (via individual stakes claim component 122). For the stake claim hash verifier component 120, a hashing function is used to verify the timestamps created from the batch timestamp 118 and/or individual stake claim 122 components. In a particular embodiment, only the hashed file or a zip file (which contains the creative work and other information) provided by the user will be able to generate the stored hash on the blockchain entry. This enables users to prove the claim/timestamp on the blockchain, including the date and time, the name of the user who created the timestamp, and other information. The timestamping component 104 may be seen as the first level of protection that a creator, or user, can use to protect their creative work.

With respect to validation component 102, the validation component 102 may be seen as a next level of protection after the timestamping component 104. The decentralized validation of intellectual property component 102 may include a validation determination component 112, a package of proof component 114 and a protection program component 116 (which may also be seen as a decentralized protection of intellectual property component). The validation determination component 112 may provide the functionality to allow creators of a creative work to increase protection of their creative work by validating the provenance of the creative work. Component 112 provides the functionality to validate the authorship, ownership, and originality, among other things, of an artist's creative work, such as in the form of a validation process. In one embodiment, the validation process may include interaction of the system, executing on the processor, with a team of global validators who work together in a gig-like fashion. In one embodiment, during the validation process, the decentralized network of certified validators may provide input to the system to validate the creative work based on validation criteria, such as, but not limited to, the point in time that the creative work was originated; the authorship and ownership of the creative work; and/or the uniqueness of the creative work. In one embodiment of the validation process, in a gig-like fashion, validators, that may be located globally, will be notified of an electronic creative work submission and the first certified validator(s) to accept the notification get the work. The results generated, or determined, by the validation determination component 112 may then be summarized in a Package of Proof (which may be generated by the package of proof component 114) that documents all steps taken to prove the authenticity of the creative work which may then be stored on the blockchain. The Package of Proof is a permanent, public record stored on the blockchain that the creator can use to prove the work is theirs.

The protection program component 116 may provide the functionality of decentralized protection of intellectual property. In one embodiment, the protection program component interacts with a set of protectors who search the internet and databases for unauthorized and/or unreported use of a creator's creative work and reports any such uses to the creator.

With respect to the protection program component 116, as part of component 102, the system may engage with a network of protectors, where the protectors may be located globally, to scour the digital and physical world for unauthorized and/or unreported use of protected creations. The network of protectors may then interact with the protection program component to assist the system in protecting the creative work from unauthorized use.

In one embodiment of use, the network of protectors may use internal and/or 3^{rd} party technology and databases to identify unreported and/or unauthorized use which is then input to the system via the protection program component 116. In one embodiment, this unauthorized use may be reported and action taken by the system such as, but not limited to, sending out demand letters with links to remedy via payment of a specified amount. In some cases, protectors may be engaged to perform routine monthly checks for unauthorized use. In other cases, the regular monitoring of unauthorized and/or unreported use of IP on platforms like ISPs, using component 116, can be seen as part of a due diligence process that ISPs may employ as part of their response to regulation and lawsuits dealing with copyright infringement on their platforms

With respect to the tokenization component 106, once a piece of creative work is validated through the validation component 102, the tokenization component 106 enables the tokenization of the creative work through non-fungible tokens (NFTs). In one embodiment, anyone can mint an NFT, whether they own the creative work or not. The system 100 and tokenization component 106 provides processes to mint NFTs that have been authenticated, or validated, by validation determination component 112, to generate validated NFTs. Only a creative work that has undergone validation, such as via validation determination component 112, will be minted as a validated NFT. Validated NFTs will include a reference to the Package of Proof generated by the package of proof component 114 and other important information to improve trust and transparency in NFTs. In the current embodiment, the tokenization component 106 includes an enforceable tokenization of intellectual property component 124. The tokenization component 106 leverages the strengths of blockchain technology while integrating and respecting the legal contracts required to make the ownership and transfer of NFTs enforceable. In some cases, validated NFTs will include relevant legal documents in the NFTs blockchain record, by way of hashing functions, to enable the transfer of NFTs in a manner that makes the transfer enforceable by the legal system. Tokenization of intellectual property component 124 also enables creators to mint child NFT(s) that are tied to the validated NFT. Child NFTs may also incorporate legal contracts, through hashing functions, to provide rights to the owners of the Child NFTs. In some cases, Child NFTs provide opportunities for monetization of the creative work, such as, for example, licensing, syndication, or the like.

With respect to the encapsulating trust, or trust component 108, the trust component 108 encapsulates trust with respect to the validated, or child, NFT. In one embodiment, the trust component 108 includes a validated NFT component 126, a NFT authenticity checker component 128, and a NFT redemption centre component 130. The encapsulation of trust component may provide trust and transparency to owners, buyers and sellers of NFTs. The encapsulation component 108 may provide the functionality to mint a validated NFT and to then, if desired, mint a collectible NFT associated with the validated NFT. These collectible and validated NFTs may be authenticated by the encapsulation component so that purchasers of these NFTs may have confirmation that they are purchasing an authentic NFT. The NFT authenticity check components 128 and the NFT redemption centre component 130 may be seen as tools that an owner, buyer or seller of NFTs can use to confirm the authenticity of the NFT and confirm information regarding the status of utilities associated with the NFT.

With respect to the monetization component 110, while components 104 (timestamping), 102 (validation), 106 (tokenization), and 108 (encapsulating trust) provide the user with the functionality or processes to protect and tokenize their creative work, the monetization component 110 provides a process for creators to monetize their creative work. In the current embodiment, the monetization component 110 includes a NFT marketplace component 134, an IP Collateralization component 136, a licensing component 138, a fractional ownership component 140, a tokenized tradeable rewards component 139, a transfer of ownership component 141, a tokenized intellectual property insurance component 143 and a music publishing admin (MPA) component 142. The monetization component may provide the functionality for a creator who owns validated creative work, a validated NFT and/or child NFT to monetize their creative work. These monetization processes are enabled by component 110 via its integration with components 104, 102, 106 and 108. The monetization component 110 may provide a plurality of different options for a creator to select and then guides the creator through the process to monetize the creative work in the selected manner. For example, by utilizing results generated by the validation component 102 and tokenization component 106, this may provide important information about the NFT and the associated creative work to an individual or corporation to collateralize the NFT or underwrite insurance on the NFT (using tokenized intellectual property insurance component 143). In another example, utilizing validation component 102, tokenization component 106, and trust component 108, a NFT marketplace (component 134) may provide more trust and transparency to NFT transactions.

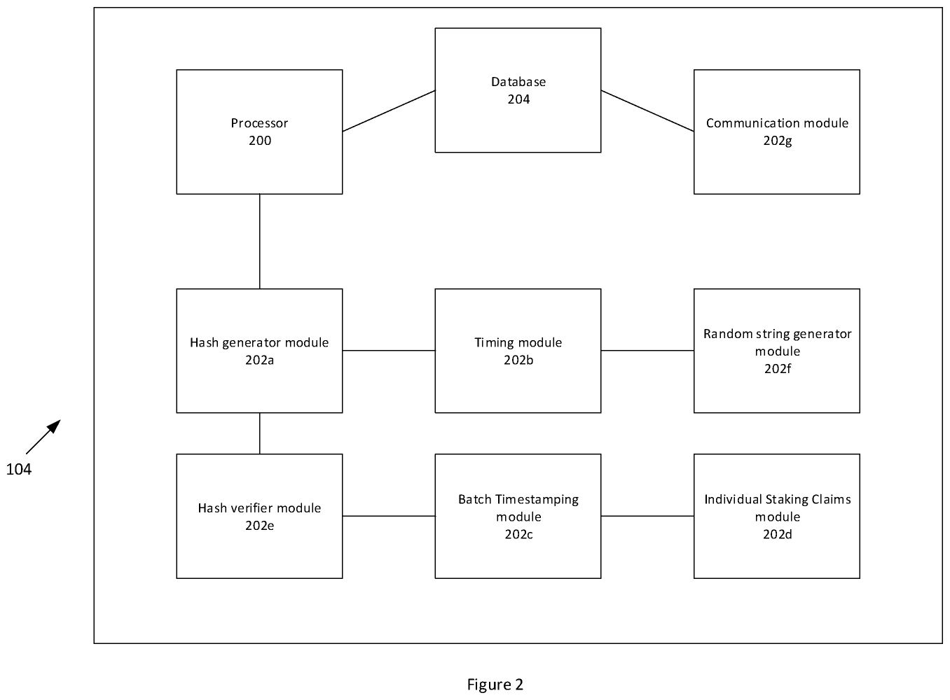

Turning to FIG. 2, a schematic diagram of an embodiment of the timestamping component is shown. The timestamping component 104 on FIG. 1 (which may also be seen as a platform for collecting information relevant to intellectual property protection related to decentralized timestamping) includes a processor 200 that communicates with a set of modules 202 that provide functionality for timestamping the submission. In one embodiment, the set of modules 202 include a hash generator module 202a, a timing module 202b, a batch timestamping module 202c, an individual staking claims module 202d, a hash verifier module 202e and a random string generator module 202f. In other embodiments, the batch timestamping module 202c and the individual staking claims module 202d may be combined in a single module and seen as, or referred to as, a staking claims module. In other embodiments, different modules may be combined into a single module that provides the functionality of the different modules. The set of modules 202 may also include a communication module 202g that enables the timestamping component to communicate with other components of the intellectual property protection and monetization infrastructure or system and a database 204. While only a few connection lines are shown between the components of the timestamping component 104, it is understood that the modules 202, the processor 200 and the database 204 may all communicate with each other to provide the decentralized timestamping of a submission of content onto a blockchain system and method. As understood, the disclosure may be implemented or stored within a computer-readable medium in the form of software code that can be executed to perform a method of timestamping a submission of content onto a blockchain.

In one embodiment, the batch timestamping module 202c provides the functionality to generate a single timestamp for multiple submissions to the system while the individual staking claims module 202d provides the functionality to generate a timestamp for an individual submission. The hash generator module 202a provides the functionality to generate a hash for use with the timestamp generated by either the batch timestamping module 202c or individual staking claims module 202d.

The hash verifier module 202e may be seen as a tool that enables any individual to verify and prove that a submission has been hashed to, written to, or stored on the blockchain by either the batch timestamping module 202c or the individual staking claims module 202d. By enabling an individual, such as the submitter or originator of the creative work, to provide proof of a hashed record, the user may be able to use the timestamped submission as evidence in cases of an intellectual property infringement or creative work dispute.

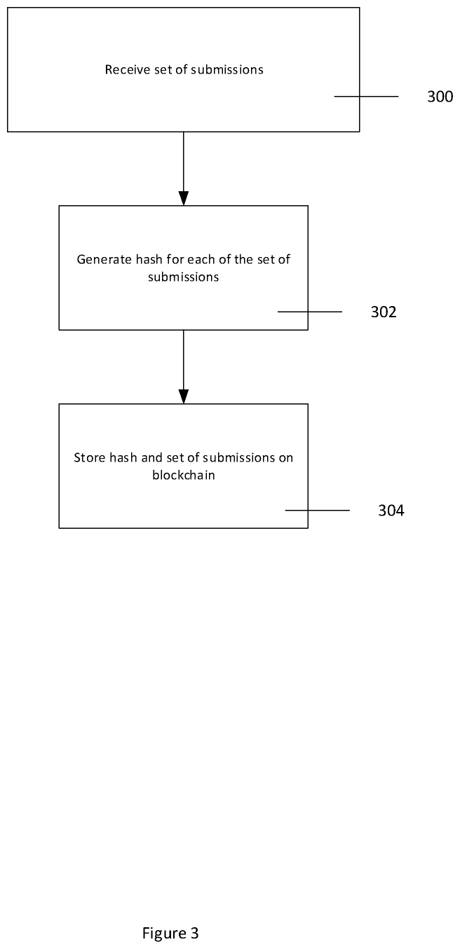

Turning to FIG. 3, a flowchart showing one method of decentralized timestamping of a submission of content onto a blockchain. In one embodiment, the method may be executed by either the batch timestamping module or the individual staking claims module. Initially, the timestamping component receives a set of verified submissions (300) for processing by either one of the batch timestamping module or the individual staking claims module. In other embodiments, the submissions may not be verified. The set of verified submissions may include one submission (such as would be received by the individual staking claims module) or more than one submission (such as would be received by the batch timestamping module).

A hash for each of the set of submissions is then generated (302). The timestamping component then stores the combination of the hash and the set of submissions on the blockchain (304). The set of submissions may include a single submission or may include more than one submission.

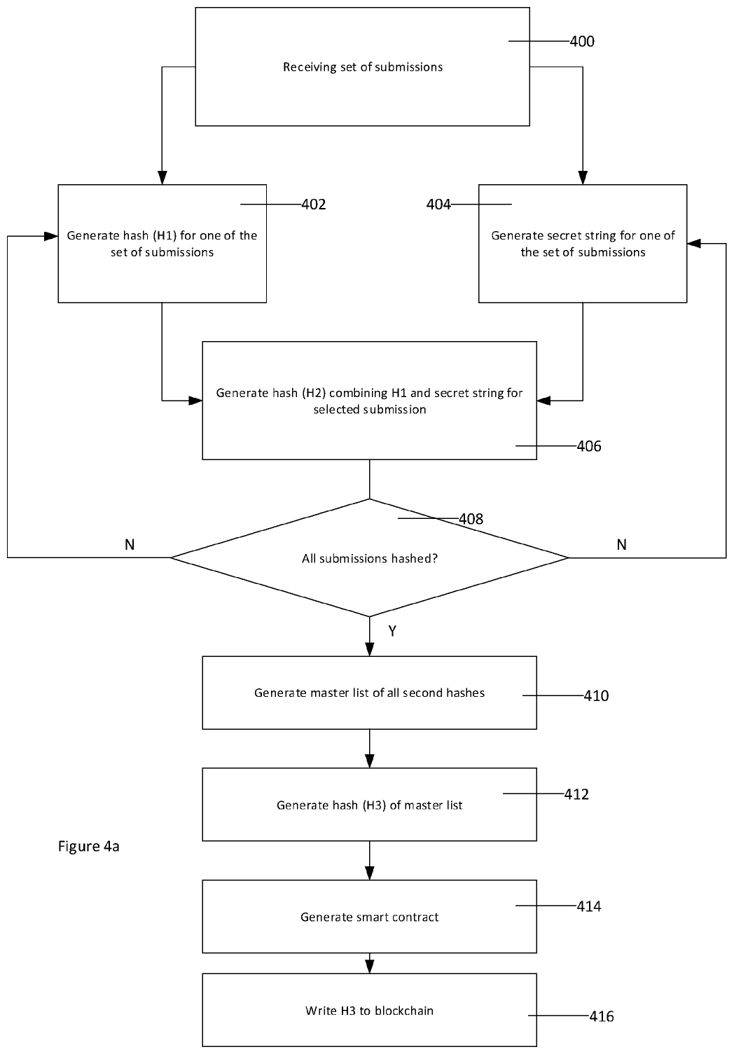

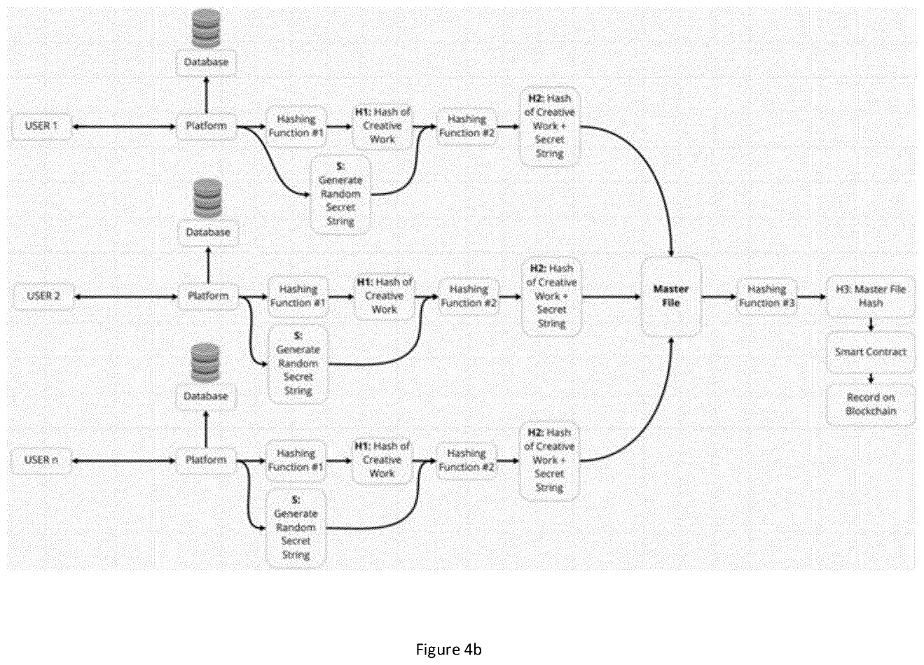

Turning to FIG. 4a, a flowchart showing one method of batch timestamping is provided while FIG. 4b provides a schematic diagram showing one specific method of batch timestamping. The method of FIG. 4a may be seen as one that is performed or executed by the batch timestamping module 202c.

Initially, multiple submissions from at least one user (or submitter) are received by the time stamping component (400). In one embodiments, the submissions may be pre-verified such that they have already been reviewed and are ready to be timestamped and stored on the blockchain. In some embodiments, the method of batch timestamping may be initiated, or triggered, based on a minimum or maximum number of submissions received, or may be initiated or triggered based on a predetermined time frame or range (such as performing the method every Sunday at 8 pm as long as there is at least one submission) or based on a predetermined date and time.

As shown in FIG. 4b, there are three (3) users that are making separate submissions to be stored on the blockchain at the same time.

Turning back to FIG. 4a, in the current embodiment, a hash for one of the set of submissions is generated (402). In one embodiment, the submission is transmitted to the hash generator module 202a that then generates a hash (H1) for the submission. The hash generator module 202a (which may also be seen as a hashing function module) provides a cryptographically secure hashing function that is secure and/or publicly available on the blockchain to generate a hash that can be used to prove the record (or submission) on the blockchain exists. In some embodiments, the individual submissions may be handled concurrently or may be processed in parallel.

While the hash is being generated (402), a random string of text, seen as a secret string(S) is generated (404). In one embodiment, the secret string is generated by the random string generator module 202f. The secret string may be used to provide security to the user such that they may provide proof that a submission belongs to the user such that others will not be able to claim ownership for the submission.

A second hash, which may be seen as a secret string and submission hash, (H2) is then generated for the selected submission (406). In one embodiment, the second hash (H2) is generated based on a combination of the secret string from (404) and the first hash (H1) from 402. The first hash includes the submission.

A check is then performed to determine if a second hash (H2) has been generated for each of the set of submissions (408). If not all of the submissions have been hashed, the batch timestamping module then performs (402), (404) and (406) for all of the remaining submissions that do not have a second hash (H2).

If the check determines that all of the set of submissions have a second hash (H2), a master list or file of the second hashes is generated (410). The master list is then hashed to generate a third hash (H3) (412). In some embodiments, a smart contract may then be generated (414) and the master list hash (H3) written to the blockchain (416). In other embodiments, the master list hash (H3) may be written to the blockchain without a smart contract being generated.

This Batch Timestamping method may also be performed on a regular basis, such as, but not limited to, daily.

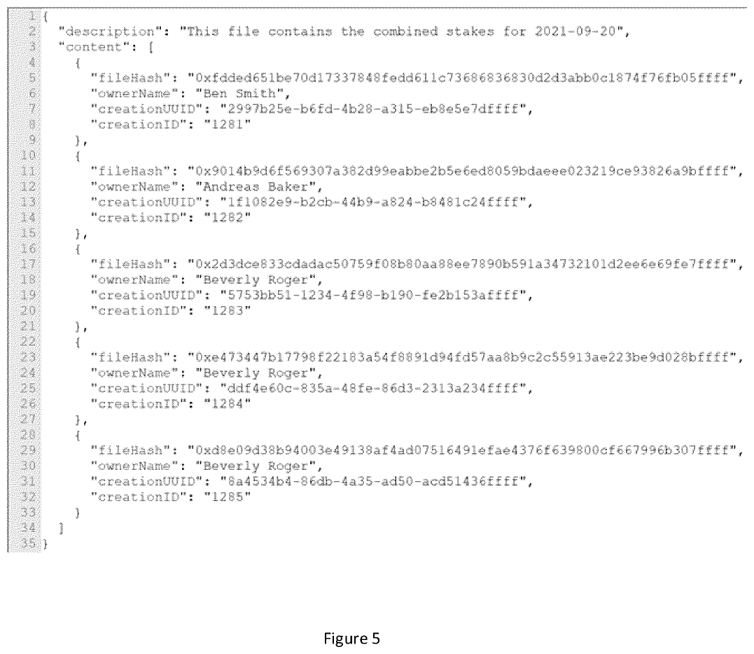

FIG. 5 provides an example of a master file where the term filehash represents the second hash (H2) from FIG. 4a. The master file may also be referred to as a hash-of-hash.

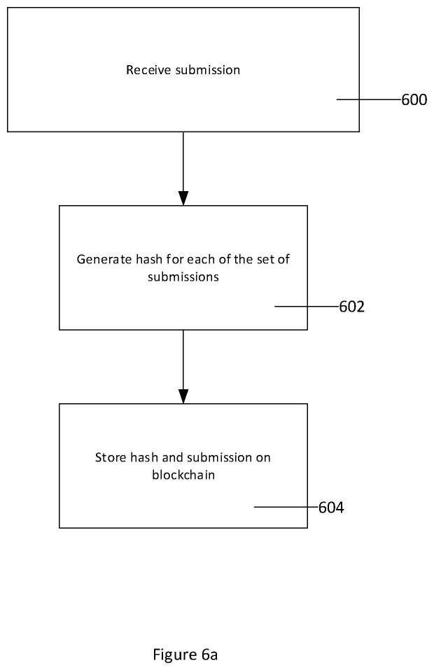

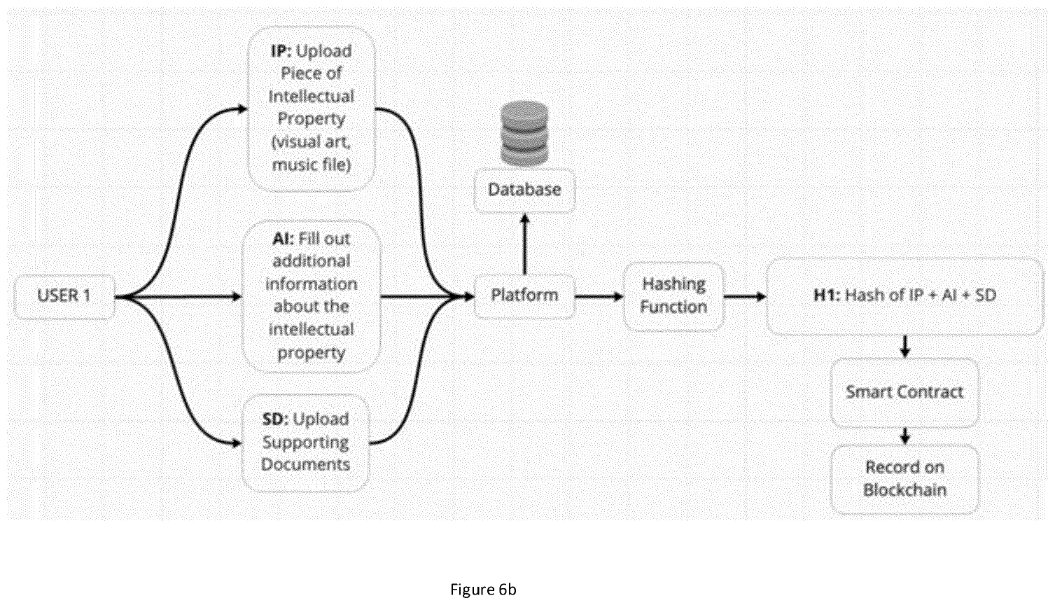

Turning to FIG. 6a, a flowchart outlining another method of performing decentralized timestamping of a submission of content onto a blockchain. In the current embodiment, only a single submission is timestamped, such as via the individual stakes claim module.

Initially, a single submission is received by the timestamping component (600). In some embodiments, the submission may also be verified as authentic, although, in other embodiments, verification may not be necessary. In this embodiment, the set of submissions is one submission. For an intellectual property protection system, the submission may include information pertinent to the protection of the creative work or submission, such as, but not limited to, supporting documents (SD) showing the authenticity and/or originality of the creative work.

The timestamping component then generates a hash for the submission (602). In one embodiment, the submission (which may include the creative work (or intellectual property), the supporting documents and any additional information (AI)) is sent to a hashing function (such as, but not limited to, the hash generator module) or a hashing function module that is dedicated to the individual staking claims module which then generates a hash of all the provided data. In another embodiment, hashing function module may generate hashes for both the batch timestamping module and the individual staking claims module. In another embodiment of the disclosure, the creative work, the additional information and the supporting documents, or the submission, may be stored or saved in a zip file before being transmitted to the hashing function to be hashed. As discussed above, the hashing function may be seen as a cryptographically secure hashing function that is secure and open sourced to provide the ability to prove a record on the blockchain. The hash is then stored or written to the blockchain (604). In one embodiment, the hashing function writes the intellectual property, the additional information and the supporting documents to the blockchain. This may be seen as H1 (in FIG. 6b).

The additional information that is submitted or collected as part of method of FIG. 6a may include information about the authorship and ownership of the creative work. In some embodiments, the additional information may be more detailed than information that is collected by other registries which provides further support to a submitter's ownership with respect to the creative work.

Table 1 below provides examples of additional information that may be collected in one embodiment of the system. In some embodiments, through the individual staking module or method, the user may be provided warnings (such as by using disclaimers) of potential issues of copyright infringement, including the implications of registering copyright for work completed under employment and similar other issues related to copyright registration. These warnings may be tailored based on jurisdictional copyright laws depending on the location of the user/creator.

TABLE 1
Examples of Additional Information Collected
for Individual Staking Claims

Are you the author/creator of this work?
Was this work completed under the course of employment?
Legal Name
Date of Birth
What was the author's residency at the time of creation of the work?
Is there more than one author/creator?
Additional Author(s) information

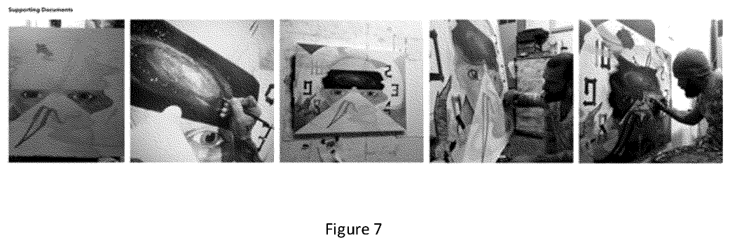

In some embodiments, the method of FIG. 6a may also facilitate the process for a user to include supporting documents. The supporting documents may provide the user with additional intellectual property protection as it facilitates the user to include proof that they are the author/owner/creator of the creative work. Examples of supporting documents include, but are not limited to, images of the user in the process of painting visual art; a sworn affidavit (witnessed by a commissioner of oaths) swearing their authorship, ownership and originality of the work; copyright assignment documents if ownership of the work was transferred; invoices or correspondence that proves authorship and/or ownership. The user may be provided with increased protection for their creative work by including a reference to all these documents on their record on the blockchain. Examples of supporting documents and/or additional information are shown in FIG. 7.

For example, assume a user completed an individual stakes claim in 2021. Further assume that in 2025, a third party begins to use the user's creative work without approval. The user will have the ability to reference their record on the blockchain, including the supporting documents, the additional information and the intellectual property (or creative work) itself and the date and time at which the creative work was recorded or timestamped to the blockchain. This will aid in their infringement, or any other, dispute.

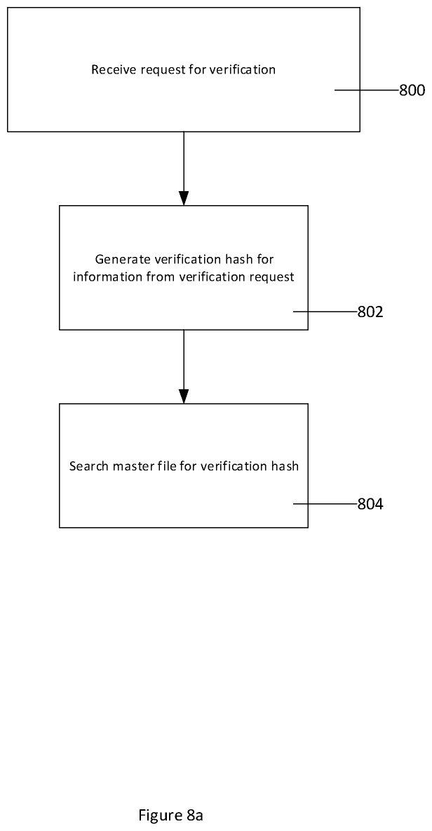

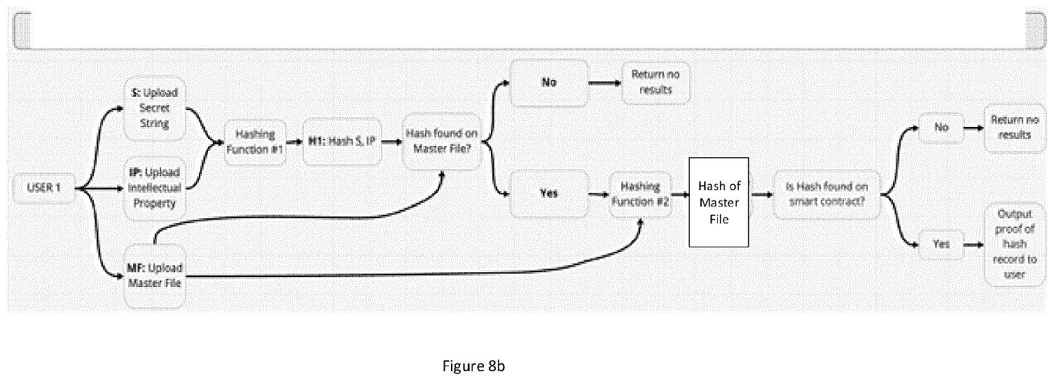

Turning to FIG. 8a, a flowchart outlining a method of verification of a previously stored batch timestamp is shown. In one embodiment, the method of verification may be performed when there is a dispute with respect to any aspect of ownership, originality of the creative work subject to one of the timestamping methods discussed above or when there is a need to prove when a creative work was created.

In order to initiate the verification, the system or timestamping component such as via the hash verification module, receives a request for verification (800). In one embodiment, the request may include the secret string (as previous generated and provided to the user (or submitter), the creative work associated with the submission to be verified and the master file. As will be understood, the information submitted with the request for verification is the same information listed above with respect to, or generated by, the method of FIG. 4a. In other embodiments, the verification request may only include the secret string and the master file or master file hash.

The information within the verification request is then transmitted to a hashing function module (such as the hash generating module) to generate another hash (which may be seen as a verification hash) based on the information (802). In other words, the secret string and the creative work (or submission) is transmitted to the hash generating module for a hash to be generated, which may be seen as the verification hash (HV). If the information that is submitted for the verification is correct or original, the verification hash should be the same as the second hash (H2) generated for the submission in FIG. 4a. A search or comparison is then performed to determine if the verification hash is in the master file (804).

In one embodiment, the hash verification module searches the master file and compares the verification hash with the previously stored hashes. If the verification hash is not found in the master file, the system notifies the user submitting the verification request that the intellectual property is not found in the record specified by the user. If the hash is found, the system notifies the person submitting the verification request that the intellectual property was hashed and written to the master file.

In another embodiment, if the verification hash is found in the master file, the hashing function module generates a hash of the master file. If successful, the hash will equal the master list hash (H3) of FIG. 4a. The system then queries the smart contract to determine if the master list hash is found. If it is not found, the master file is not found on the blockchain. If it is found, the system will output a record of the results found on the blockchain. This proves to the user that the creation is found on the blockchain.

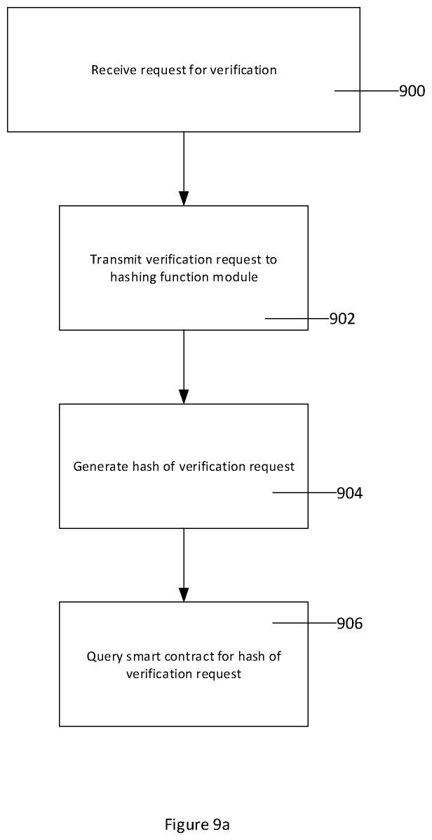

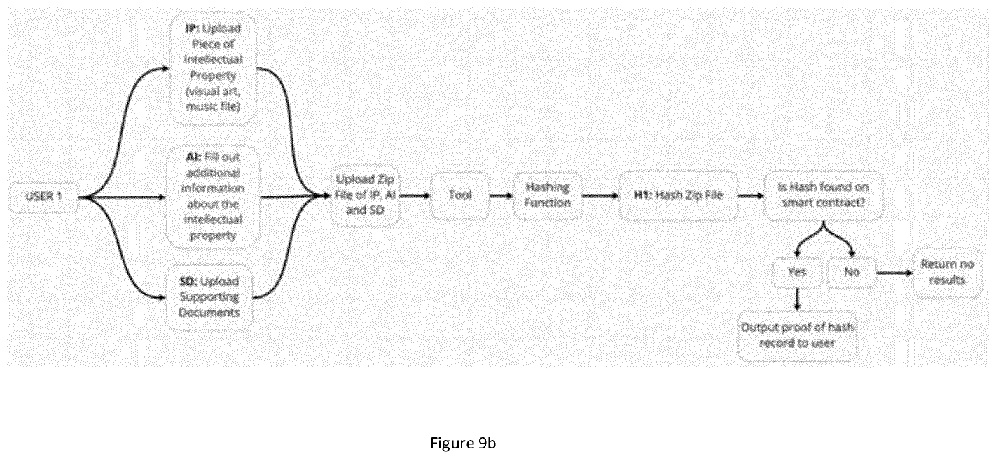

Turning to FIG. 9a, a flowchart outlining a method of verification for an individual staking claims submission is shown. Initially, the system receives a request for verification (900). In one embodiment, the verification request may include a ZIP file that includes the creative work and a combination of the additional information and/or the supporting documents. Upon receipt of the request for verification, the ZIP file is transmitted to a hashing function (902).

In one embodiment, the ZIP file (which may be seen as the verification request) may be transmitted to the hash generating module. A hash of the ZIP file is then generated (904). The hash may be seen an individual stakes verification hash. In one embodiment, the hash generating module may generate a hash of the ZIP file.

The system then queries the smart contract to determine if the individual stakes verification hash that was generated for the ZIP file is found (906). If the hash of the ZIP is not found in the smart contract, the system determines that the creative work has not been previously stored in or written on the blockchain. If the hash of the ZIP is found in the smart contract, the system determines that the creative work has been stored or written to the blockchain and may display this information to the user (or person requesting verification). A more specific embodiment of the method of FIG. 9a is shown in FIG. 9b.

In one embodiment, system and method of the disclosure provides a user who wishes to protect their intellectual property with the ability to do so in a cost-effective, efficient and effective manner. Users that upload their intellectual property and associated information for Batch Timestamping will have their intellectual property and associated information hashed to the blockchain as described above. With Batch Timestamping, the intellectual property (e.g. artwork, music, literary work) will be hashed to the blockchain with a group of other pieces of intellectual property, rather than an individual hash for each piece of intellectual property. By recording their date, name and intellectual property on the blockchain, users will have an immutable and public record of their intellectual property. By combining the intellectual property and associated information in a batch, it allows the user to obtain protection for their creative work in a cost-effective manner.

In another embodiment, the disclosure provides a user who wishes to protect their intellectual property with the ability to do so in a cost-effective, efficient and effective manner. Users that upload their intellectual property and associated information for individual staking claims will have their intellectual property and associated information hashed to the blockchain. Unlike batch timestamping, the intellectual property (e.g. artwork, music, literary work) uploaded by users for individual staking claims will be hashed to the blockchain in an individual hash for each piece of intellectual property. By staking a claim individually, creators have more protection for their creative work.

First, through individual staking claims, the user has their own dedicated hash on the blockchain. Second, individual staking claims allows the users to create a record on the blockchain, that can reference important information such as, but not limited to, authorship details, artist residency, employment information and date of creation and the like. Similar evidence may be beneficial for other types of intellectual property. Third, in one embodiment of the disclosure, the disclosure provides creators with the ability to attach a single hashed version of supporting documents to the record, or a submission, on the blockchain. By writing these supporting documents to the hash on the blockchain, the creator is provided an additional level of proof that the creator can reference in the future. Table 2 provides some differences between a batch timestamping submission method and an individual staking claims submission method:

TABLE 2

| | | Individual |
|---|---|---|
| | Batched | Staking |
| Protection | Time-Stamp | Claims |
| Hash on blockchain | Y | Y |
| Dedicated Hash on blockchain | N | Y |
| Creator's name and date included in hash | Y | Y |
| Creator's name, date and other important | N | Y |
| authorship and ownership information | | |
| included in hash | | |
| Attach supporting files that help prove | N | Y |
| authorship and/or ownership | | |

In another embodiment of the disclosure, the disclosure provides a system and method for a user to protect their creative work without needing to publically show the creative work. This may be important for those creative works that users are especially protective of and want to keep private.

For example, the user is able to use their own hash function in order to keep their creative work (or intellectual property) private from a centralized intermediary or may be able to select from a list of pre-loaded hash functions. The system allows or enables the user to use their hash as a representative of the creative work without needing to show the intellectual property to the public. In this embodiment, the user will have the option to use their hash function as proof of their creative work. The disclosure also enables a user to cryptographically secure their intellectual property while still protecting their intellectual property through timestamping their submission. The user may cryptographically secure the intellectual property and upload the encrypted version of the intellectual property to the disclosure. The encrypted intellectual property will then be hashed to the blockchain. If the user wishes to prove the claim on the blockchain in future, they will need to include the decryption key to reveal the intellectual property. In this embodiment, the user can also choose to time-delay the encryption whereby the disclosure can decrypt the encrypted intellectual property after a certain time period stipulated by the user.

In the preceding description, for purposes of explanation, numerous details are set forth in order to provide a thorough understanding of the embodiments. However, it will be apparent to one skilled in the art that these specific details may not be required. It will also be understood that aspects of each embodiment may be used with other embodiments even if not specifically described therein. Further, some embodiments may include aspects that are not required for their operation but may be preferred in certain applications. In other instances, well-known structures may be shown in block diagram form in order not to obscure the understanding. For example, specific details are not provided as to whether the embodiments described herein are implemented as a software routine, hardware circuit, firmware, or a combination thereof.

Embodiments of the disclosure or elements thereof can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with other modules and elements, including circuitry or the like, to perform the described tasks.

The above-described embodiments are intended to be examples only. Alterations, modifications and variations can be effected to the particular embodiments by those of skill in the art without departing from the scope, which is defined solely by the claim appended hereto.

What is claimed is:

1. A method for decentralized timestamping of a submission of content onto a blockchain comprising:
receiving a set of submissions;
generating a hash for each of the set of submissions; and
writing each hash to the blockchain.

2. The method of claim 1 wherein the set of submissions comprises at least two submissions.

3. The method of claim 2 wherein writing each hash to the blockchain comprises:
generating a secret string for each of the set of submissions;
generating a secret string and submission hash for each of the set of submissions;
generating a master file hash including each of the secret string and submission hashes; and
writing the master file hash to the blockchain.

4. The method of claim 1 further comprising, before generating a hash for each of the set of submissions,
transmitting each of the set of submissions to a hash generating module.

5. The method of claim 1 wherein each of the set of submissions comprises:
a creative work; and
at least one of additional information or supporting documents.

6. The method of claim 1 wherein the set of submissions comprises a single submission.

7. The method of claim 6 wherein the hash comprises a creative work associated with the single submission.

8. The method of claim 7 wherein the hash further comprises supporting documents associated with the creative work.

9. The method of claim 7 wherein the hash further comprises additional documents associated with the creative work.

10. A system for decentralized timestamping of a submission of content onto a blockchain comprising:
a processor for receiving a set of submissions for decentralized timestamping;
at least one timestamping module for generating a timestamp for the set of submissions; and
a hash generating module for generating a hash for each of the set of submissions;
wherein the processor writes the set of submissions, a timestamp and the hash to the blockchain after the hash has been generated.

11. The system of claim 10 wherein the at least one timestamping module is a batch timestamping module.

12. The system of claim 11 wherein the batch timestamping module generates a secret string for each of the set of submissions and the hash generating module generates a hash for each of the set of submissions.

13. The system of claim 12 wherein the hash generating module generates a secret string and submission hash for each of the set of submissions.

14. The system of claim 13 wherein the hash generating module generates a master file hash comprising each of the secret string and submission hashes.

15. A method of timestamping verification of a submission that has been written to a blockchain comprising:
receiving a verification request;
generating a verification hash based on the verification request; and
searching a master file on the blockchain for the verification hash.

16. The method of claim 16 further comprising, if the verification hash is found in the master file,
determining if the master file is listed within a smart contract associated with the blockchain.

17. The method of claim 15 searching a master file on the blockchain for the verification hash comprises:
comparing the verification hash with a list of previously generated hashes stored within the master file.
